(19) United States
(12) Patent Application Publication
(10) Pub. No.: US 2026/0164011 A1
(43) Pub. Date: Jun. 11, 2026

(54) CAMERA INSPECTION SYSTEM AND CAMERA INSPECTION METHOD

(71) Applicant: Renesas Electronics Corporation, Tokyo (JP)

(72) Inventor: Satoshi KATAYANAGI, Tokyo (JP)

(21) Appl. No.: 19/371,025

(22) Filed: Oct. 28, 2025

(30) Foreign Application Priority Data
Dec. 6, 2024 (JP) 2024-213072

(51) Int. Cl. H04N 17/00; G06T 7/00; H04N 23/74

(52) U.S. Cl. CPC H04N 17/002; G06T 7/0002; H04N 23/74; G06T 2207/30168

(57) ABSTRACT

The camera inspection system includes an external environment changer that receives an inspection signal and changes the imaging illumination of a camera fixed to a vehicle, thereby changing the brightness within the frame image captured by the camera. It also includes an average brightness calculator that calculates the average brightness within the image for each frame image captured within a predetermined period by the camera, and an inspector that compares the inspection signal with the average brightness within the image for each frame image and generates a fault detection signal indicating image fixation when the timing of the change in the inspection signal does not match the change in the average brightness within the image.

### CROSS-INSPECTION SYSTEM AND CAMERA INSPECTION METHOD

The disclosure of Japanese Patent Application No. 2024-213072 filed on December 6, 2024, including the specification, drawings and abstract is incorporated herein by reference in its entirety.

### BACKGROUND

This disclosure related to a camera inspection system and a camera inspection method.

There are disclosed techniques listed below.

Patent Document 1 Japanese Unexamined Patent Application Publication No. 2015-131635

Patent Document 2 Japanese Unexamined Patent Application Publication No. 2012-035677

A fixation failure of a video signal, such as a camera where a specific image continues to be displayed, can be detected by observing, for example, that there is very little change in each frame image of the video. This method involves comparing the pixel information of a previous still image with that of subsequent still images and determining a failure when there is little change.

However, this method requires constantly comparing the entire image of each frame, which presents the problem of a large amount of computation. To solve this, a method is also employed where error correction codes (such as CRC codes) are calculated for each image data, and only the changes in the error correction codes are compared between frames to reduce the computation amount.

### SUMMARY

However, although this method can detect video fixation, to determine whether it is an actual failure or simply the same scene being captured by the camera, it is necessary for a vehicle driver to make a judgment through other means such as visual inspection. Such circumstances can particularly lead to reduced availability due to pseudo-errors in systems like autonomous driving systems.

Currently, if video fixation occurs in an in-vehicle camera, the driver can respond by ignoring the in-vehicle camera's video and visually checking the surroundings of the vehicle. However, such techniques cannot be applied to highly available systems like level 3 or higher autonomous driving systems (where the automated driving device substitutes all driving operations in a limited area that meets specific driving environment conditions).

This disclosure is made to solve such problems and aims to provide a camera inspection system and method that can determine the presence of abnormalities such as video fixation in a relatively easy manner. Other objects and novel features will become apparent from the description of this specification and the accompanying drawings.

The camera inspection system according to this disclosure includes an external environment changer that receives an inspection signal and changes the imaging illumination of a camera fixed to a vehicle, thereby changing the brightness within the frame image captured by the camera; an average brightness calculator that calculates the average brightness within the image for each frame image captured by the camera within a predetermined period; and an inspector that compares the inspection signal with the average brightness within the image for each frame image and generates a failure detection signal indicating video fixation when the timing of changes in the inspection signal and the average brightness within the image do not match.

The camera inspection method according to this disclosure includes receiving an inspection signal and changing the imaging illumination of a camera fixed to a vehicle, thereby changing the brightness within the frame image captured by the camera; calculating the average brightness within the image for each frame image captured by the camera within a predetermined period; and comparing the inspection signal with the average brightness within the image for each frame image and generating a failure detection signal indicating video fixation when the timing of changes in the inspection signal and the average brightness within the image do not match.

According to this disclosure, it is possible to provide a camera inspection system and method that can determine the presence of abnormalities during video fixation in a relatively easy manner.

### BRIEF DESCRIPTION OF THE DRAWINGS

FIG. 1 is a block diagram illustrating the configuration of the camera inspection system according to the first embodiment.

FIG. 2 is a block diagram illustrating the overall configuration of the camera inspection system according to the second embodiment.

FIG. 3 is a graph showing the inspection signal, frame period, average brightness, and failure detection signal.

FIG. 4 is a diagram explaining the operating principle of the camera inspection method according to this disclosure.

FIG. 5 is a diagram showing a modified example of the camera unit according to the second embodiment.

FIG. 6 is a diagram showing a modified example of the camera unit according to the second embodiment.

FIG. 7 is a diagram showing a modified example of the camera unit according to the second embodiment.

FIG. 8 is a diagram showing a modified example of the camera unit according to the second embodiment.

FIG. 9 is a diagram explaining the configuration of the camera unit according to the third embodiment.

### DETAILED DESCRIPTION

### First Embodiment

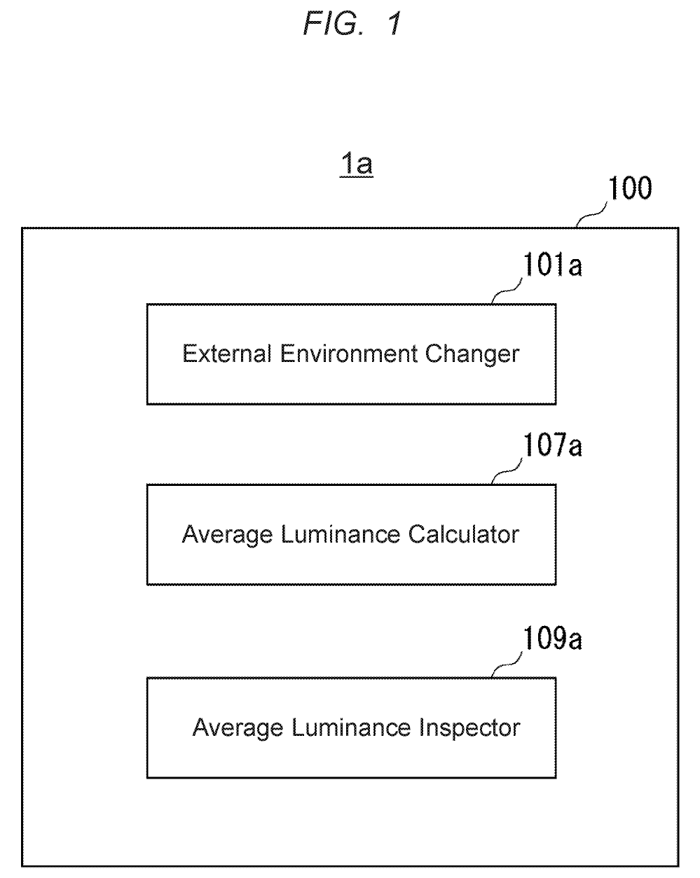

Hereinafter, embodiments of the present disclosure will be described with reference to the drawings. FIG. 1 is a block diagram illustrating the configuration of a camera inspection system according to the first embodiment. The camera inspection system can be used to determine the presence of abnormalities such as image sticking in images captured by a camera fixed to a vehicle. The camera inspection system 1a may include an in-vehicle ECU (Electronic Control Unit) that controls the system using electronic circuits. As shown in FIG. 1, the camera inspection system 1a includes an external environment changer 101a, an average luminance calculator 107a, and a luminance inspector 109a.

The external environment changer 101a receives an inspection signal and changes the imaging illuminance of the camera fixed to the vehicle, thereby changing the luminance within the frame image captured by the camera. The external environment changer 101a may be an inspection light or an additional function device of the camera (such as a shutter, aperture, or focus adjustment).

The inspection signal mentioned here may include signals indicating illuminance modulation by binary changes (ON/OFF, such as square waves), sine waves, sawtooth waves, or modulation by known patterns such as PRBS signals, or using a unique identifier such as a vehicle identification number as the seed value of a known pattern like a PRBS signal. In some embodiments, the inspection signal may be a signal (single pulse wave) generated at any timing by the operation of the vehicle driver. Additionally, the inspection signal may be a signal (single pulse wave) generated only once when an MCU (microcontroller unit) included in the ECU detects an abnormality in the camera. In response to such inspection signals, the external environment changer 101a can change the imaging illuminance of the camera fixed to the vehicle. Consequently, the luminance within the frame image captured by the camera can be changed.

As used herein, the term “imaging illuminance” refers to the optical brightness of the subject or the incident light on the camera. The term “luminance” refers to the brightness in the image signal (luminance signal, Y signal). An “image” refers to a still image, that is, an image per frame. A “video” refers to the above images connected in time and may also be called a moving image.

The average luminance calculator 107a calculates the average luminance within the image for each frame image captured by the camera over a predetermined period. The average luminance within the image may be the average luminance of all pixels within the image or a locally averaged luminance calculated by sampling several locations within the image where luminance changes may occur.

The average luminance inspector 109a compares the inspection signal with the average luminance within the image for each frame image and generates a fault detection signal indicating image sticking when the timing of the change in the inspection signal does not match the change in the average luminance within the image. The luminance inspector 109a may use the average luminance difference value between the previous frame and the current frame instead of the average luminance information and compare the amount of inspection signal information with the average luminance difference value.

According to the camera inspection system and method related to the first embodiment described above, it is possible to determine the presence of abnormalities such as image sticking relatively easily.

### Second Embodiment

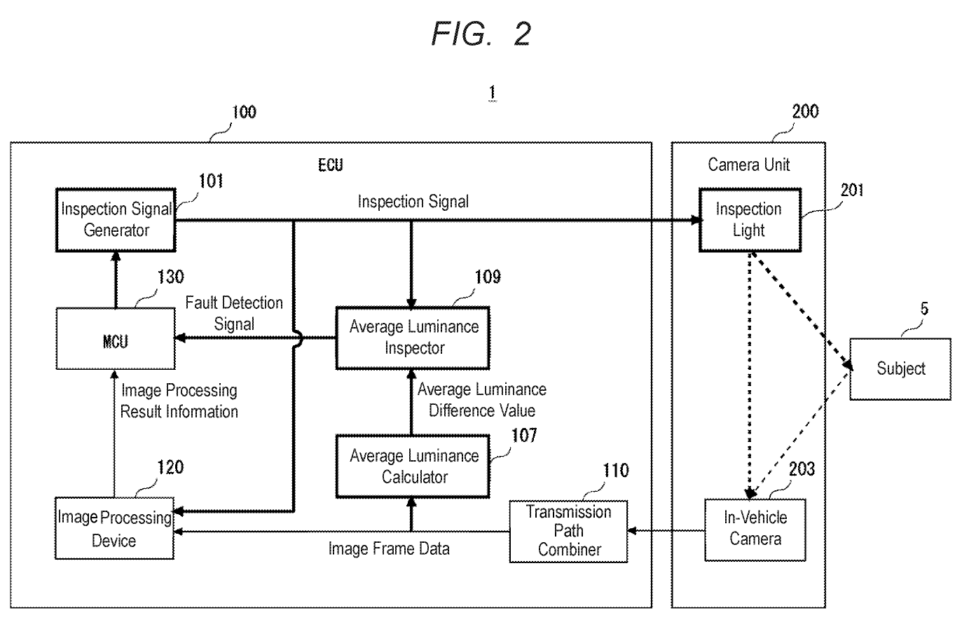

FIG. 2 is a block diagram illustrating the overall configuration of a camera inspection system according to the second embodiment. The camera inspection system 1 includes an ECU 100 and a camera unit 200 that captures an image of a subject 5.

The ECU 100 includes an inspection signal generator 101, an MCU (microcontroller unit) 130, an image processing device 120, a transmission path combiner 110, an average luminance calculator 107, and an average luminance inspector 109. The camera unit 200 includes an inspection light 201 and an in-vehicle camera 203.

The in-vehicle camera 203 is one or more cameras fixed to the vehicle, such as a front camera facing the forward direction of the vehicle (driver's view), a rear camera facing the rear direction of the vehicle, or side cameras on the left and right, but is not limited to these. Subject 5 is an object around the vehicle, such as a pedestrian, another vehicle, a bicycle, or a road sign, which may affect the driving of the vehicle, but is not limited to these.

The transmission path combiner 110 converts various signals (including analog and digital signals) from the in-vehicle camera into RGB signals or YCbCr signals for video signal analysis described later and sends the image frame data to the average luminance calculator 107 and the image processing device 120. The conversion between RGB signals and YCbCr signals can be performed using appropriate conversion formulas described in ITU-R BT.601 or the like.

The image processing device 120 receives image frame data from the transmission path combiner 110 and performs various image processing. Examples of image processing include object recognition technology for subject 5 within the image frame but are not limited to this. Various image processes related to autonomous driving can be performed. The image processing device 120 may execute image processing such as ignoring (or removing) the image frame when a fault detection signal indicating image sticking is received, retaining the previous image frame, or complementing the image based on the preceding and succeeding frame signals (complementing the average value for each pixel of the preceding and succeeding frames). The image processing device 120 may perform luminance correction in synchronization with the period for those to which periodic variations such as sine waves or sawtooth waves are applied. For example, the image processing device 120 can remove the frame image corresponding to the generated fault detection signal and complement the image based on the preceding and succeeding frame images of the removed frame image. This allows maintaining the accuracy of image processing (such as object recognition).

The MCU 130 is a semiconductor in which peripheral functions such as a CPU (Central Processing Unit) and memory are integrated into a single chip. The MCU 130 receives the image processing results from the image processing device 120 and executes various processes such as vehicle control (steering operation, brake control, etc.). Additionally, the MCU 130 can determine image sticking by receiving a fault detection signal from the average luminance inspector 109, as described later, and can modify the image processing result information. Furthermore, the MCU 130 can execute various processes on the inspection signal generator 101. The inspection signal generator 101 may be, for example, a periodic pulse or PRBS generator, and the MCU 130 can set the period or type of generated signal for the inspection signal generator 101 and notify instructions (triggers) for activation and termination.

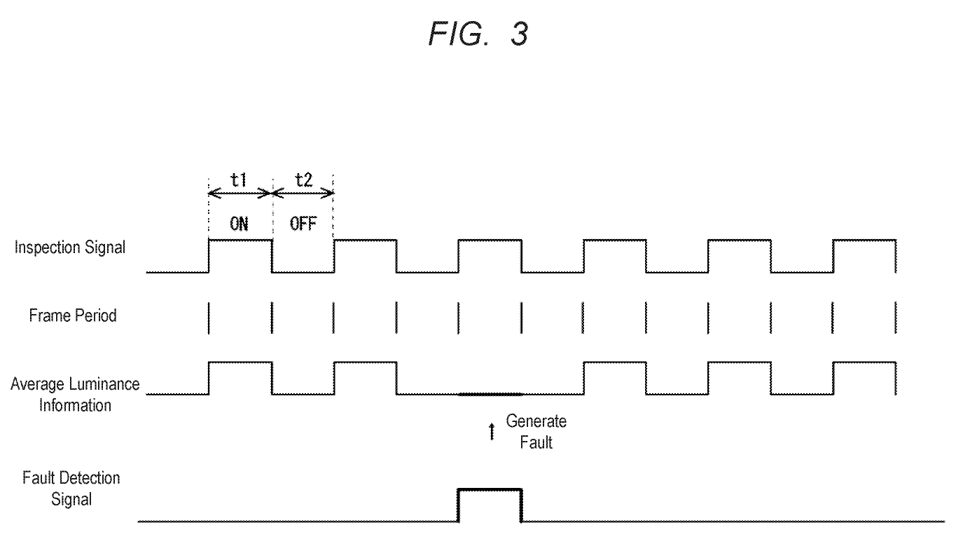

Next, the characteristic part of the present disclosure for determining image sticking will be described in more detail. FIG. 3 is a graph showing the inspection signal, frame period, average luminance, and fault detection signal. For convenience, actual signal delays and the like that may occur are omitted from the description. In this example, the inspection signal is a blinking signal, and the camera unit 200 has an inspection light 201. Particularly, the blinking information period and the frame period are assumed to be synchronized for convenience. Techniques for synchronously capturing image signals obtained from blinking information include CDR (Clock Data Recovery) technology using DLL, PLL, or sampling technology that performs sufficiently fast image capture, allowing adjustment of the blinking information period and frame period. The inspection lamp and imaging timing may be electrically synchronized in advance. Note that this graph is merely illustrative and does not limit the present disclosure.

The inspection signal generator 101 generates an inspection signal that periodically switches on and off, as shown in FIG. 3, and sends it to the inspection light 201 described above. In this embodiment, since the inspection light is particularly made to blink, the inspection signal generator 101 may also be called a blinking signal generator.

The length of the inspection time may be for each frame of the camera image, several times the number of frames of the camera image (about 2 to 5 times), or more than the above (about seconds), but is not limited to this. The frequency of inspection may be every 1 to 2 frames, about every second, only at key-on (vehicle start), the average failure interval of the camera, or about a fraction of that, but is not limited to this. These can be appropriately selected based on the purpose of use of the camera.

The inspection light 201 receives the inspection signal that periodically switches on and off and blinks according to the inspection signal, periodically changing the illuminance of the external environment of the lens of the in-vehicle camera 203 (i.e., the surrounding environment of subject 5). As a result, the luminance within the frame image captured by a normal in-vehicle camera 203 changes according to the inspection signal. Conversely, the luminance within the frame image captured by an in-vehicle camera 203 with abnormalities such as image sticking does not change.

In FIG. 3, a test signal that periodically switches on and off (such as a square wave) is shown, but the present disclosure is not limited to this. For example, the test signal may be a signal indicating illumination modulation by a sine wave, sawtooth wave, or the like. Additionally, the test signal may be a signal indicating modulation by a known pattern such as a PRBS (Pseudo Random Binary Sequence) signal. By using PRBS as the test signal, it is possible to reduce the effects of changes in the external environment of the vehicle (coincidental matches) and the influence from other vehicles conducting similar tests. Alternatively, the test signal may use a unique identifier such as a vehicle identification number or an identifier generated by a True Random Number Generator (TRNG) as the seed value of a known pattern like a PRBS signal. This further reduces the influence from other vehicles.

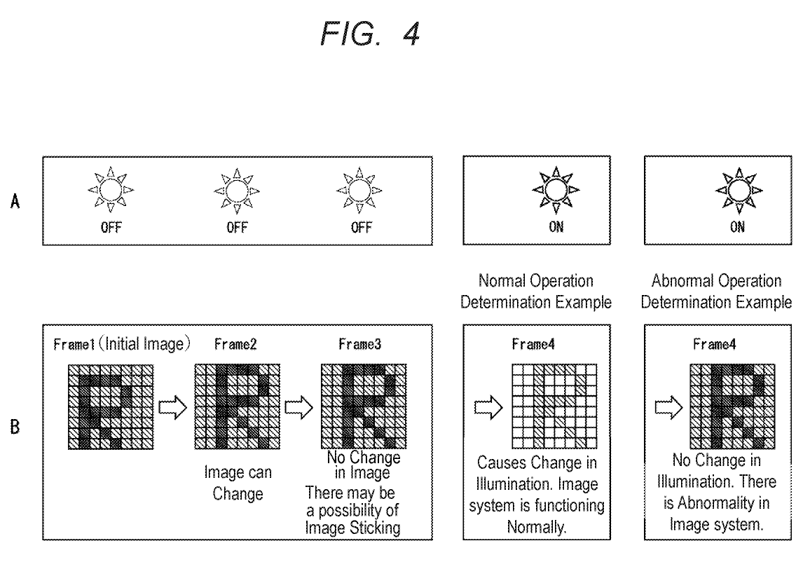

FIG. 4 is a diagram illustrating the operating principle of the camera inspection method according to the present disclosure. A indicates the state (i.e., on or off) of the inspection light 201, and B indicates the brightness state of the input frame image. Each frame obtained from the onboard camera may change as the vehicle's surrounding environment transforms, such as when the vehicle is in motion. Typically, the image can change from the initial frame 1 to the subsequent frame 2. However, if there is no change in the image from frame 2 to frame 3, there may be a possibility of image sticking (although it cannot be determined if the same scene is simply being captured by the camera).

Therefore, by turning on the inspection light 201, which changes the illumination of the external environment of the lens of the onboard camera 203 (i.e., the surrounding environment of the subject 5) is possible to determine the presence or absence of image sticking. In a normal operation determination example, turning on the inspection light 201 causes a change in the illumination in the external environment of the onboard camera, allowing it to be determined that the onboard camera itself is functioning normally. On the other hand, in an abnormal operation determination example, if there is no change in the illumination in the external environment of the onboard camera when the inspection light 201 is turned on, it can be determined that there is an abnormality in the onboard camera, namely, that image sticking is occurring.

The average brightness calculator 107 calculates the average brightness within the image for each frame image captured by the in-vehicle camera 203 over a predetermined period. FIG. 3 shows the average brightness after binarization shaping. The average brightness information within one frame image can be calculated, for example, by integrating (counting) the Y signal within the frame time. It should be noted that instead of calculating the average brightness of all pixels in the image, the average brightness calculator 107 may sample several locations within the image (where brightness changes may occur) to calculate local average brightness information. This can reduce the amount of computation.

The average luminance inspector 109 compares the inspection signal with the average luminance within each frame image and generates a fault detection signal indicating image sticking when the timing of periodic on and off switching does not match (see FIG. 3). In this way, a simple comparison of the inspection signal and average luminance information timing may be performed. Alternatively, the High width and Low width (FIG. 3) set in the inspection signal may be monitored using a counter or the like.

The average luminance inspector 109 may use the average luminance difference value between the previous frame and the current frame instead of “average luminance information,” and compare the lighting and extinguishing information of the blinking information with the amount of average luminance difference value.

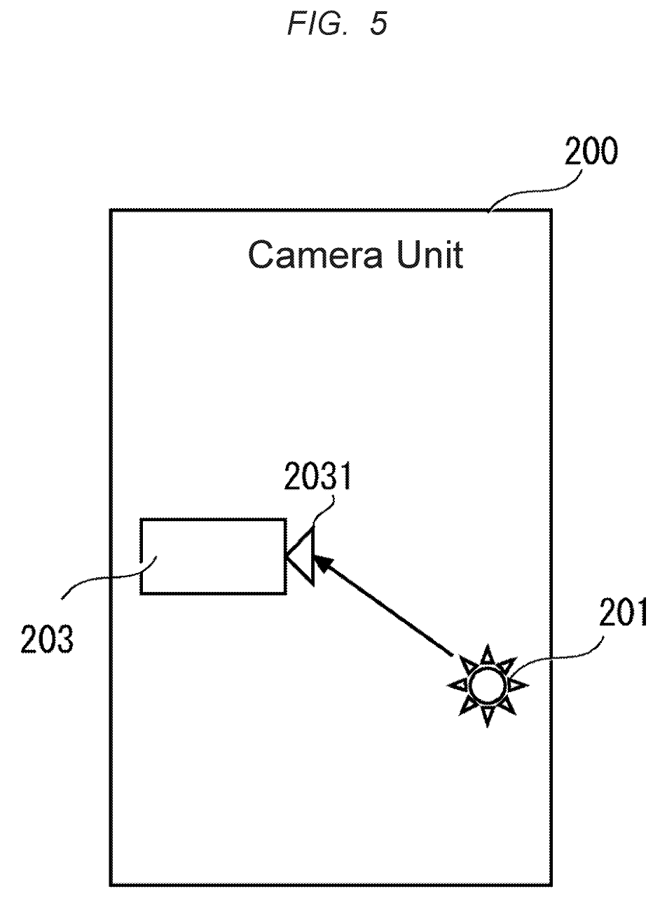

Here, the external environment changer 101a of the first embodiment corresponds to the combination of the camera unit 200, which includes the inspection light 201, and the inspection signal generator 101 of the second embodiment. However, various modified examples of the camera unit are conceivable, as shown below. FIGS. 5 to 8 illustrate modified examples of the camera unit.

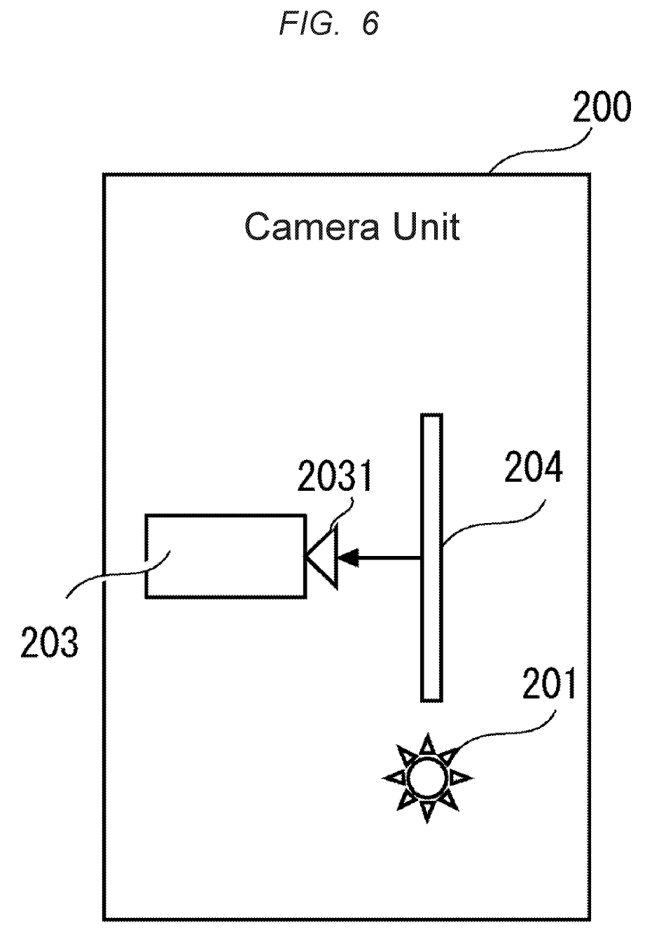

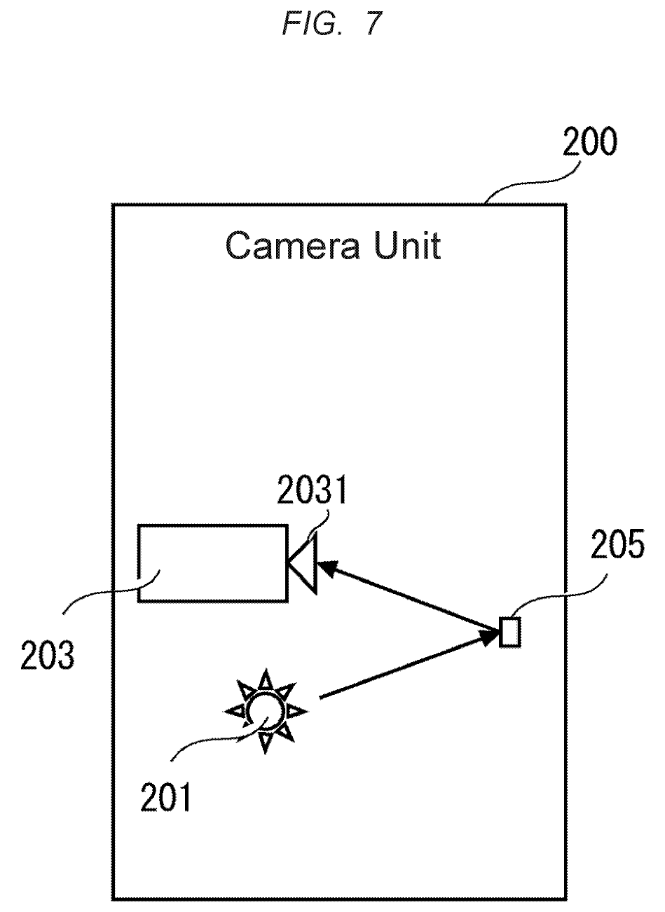

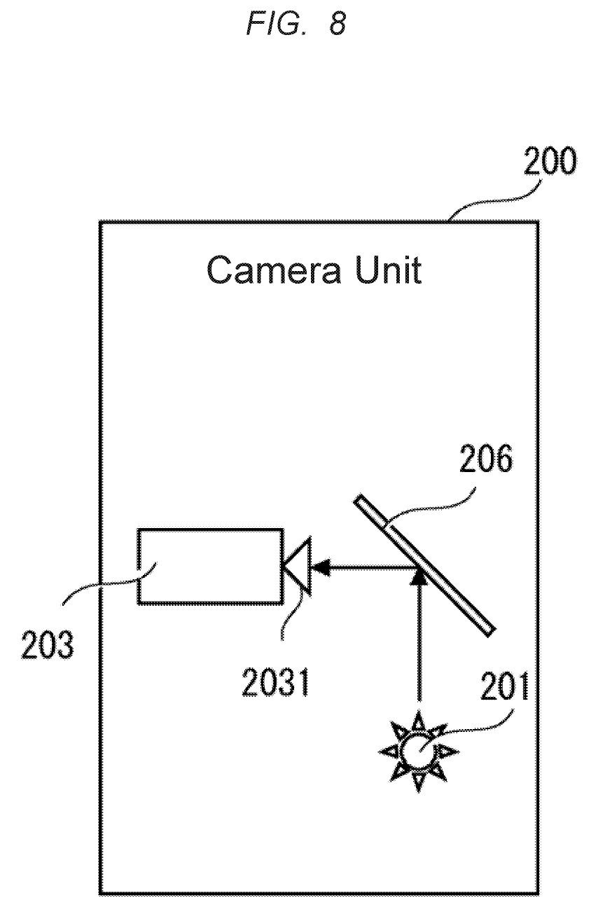

In FIG. 5, the inspection light 201 is installed within the angle of view range of the lens 2031 of the camera 203, directly illuminating the external environment of the subject and the lens. FIG. 6 shows the light from the inspection light 201 illuminating the external environment of the subject and the lens using a light guide plate 204. FIG. 7 shows a reflector 205 installed at the edge of the angle of view of the lens 2031 of the camera 203, reflecting the light from the inspection light 201 with the reflector 205 to illuminate the external environment of the subject and the lens. FIG. 8 shows a half mirror 206 installed within the angle of view of the lens 2031 of the camera 203, reflecting part of the light from the inspection light 201 with the half mirror 206 to illuminate the external environment of the subject and the lens.

The inspection light may not be directly captured by the camera but may be a light that can sufficiently change the illuminance of the subject (imaging target) of the camera. Additionally, the inspection light may not use visible light (e.g., infrared/ultraviolet LEDs). The inspection light may utilize lights equipped in conventional vehicles (backup lamps, hazard lamps, headlights, auxiliary lamps, welcome lamps, and other lights). This allows for the easy realization of a camera inspection system. A redundant configuration may be adopted by simultaneously or phase-shifting the irradiation of multiple inspection lights.

According to the camera inspection system described above, it is possible to inspect the presence or absence of image sticking in an in-vehicle camera without performing complex calculations.

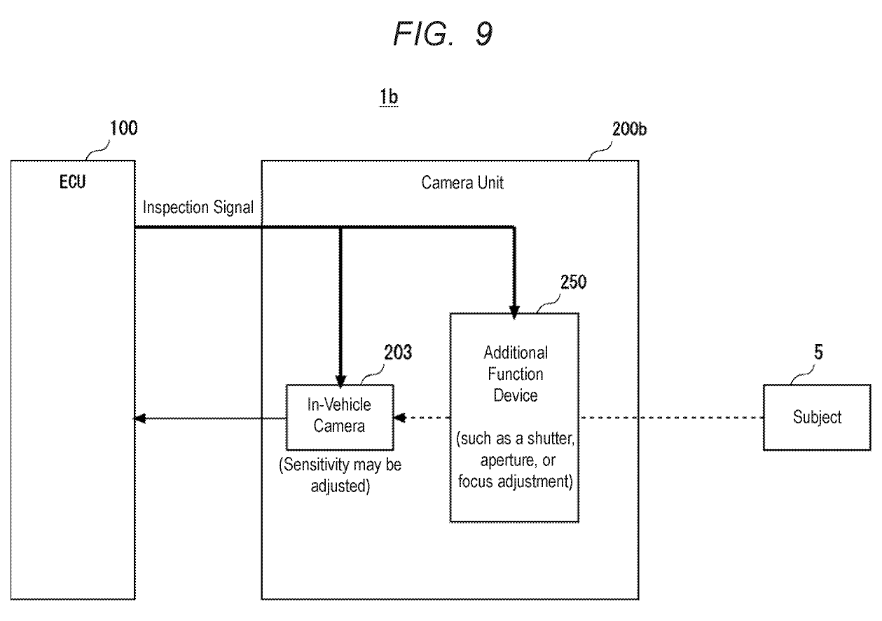

FIG. 9 is a diagram illustrating the configuration of a camera unit according to the third embodiment. Although ECU100 is also depicted in FIG. 9, it is the same as in FIG. 2, so the details are omitted. The camera unit 200b according to the third embodiment differs from the camera unit 200 of the second embodiment in that it has an additional function device 250 for the camera instead of the inspection light 201. The additional function device 250 of the camera may include a shutter, aperture, focus adjuster, etc. These additional function devices 250, like the inspection light of the second embodiment, receive an inspection signal that periodically switches on and off, and by exerting the additional function according to the inspection signal, the illuminance of the external environment of the lens of the camera 203 (i.e., the surrounding environment of the subject) can be periodically changed. As a result, the luminance within the frame image captured by a normal in-vehicle camera 203 changes. Conversely, the luminance within the frame image captured by an in-vehicle camera 203 with abnormalities such as image sticking does not change.

The external environment changer 101a of the first embodiment corresponds to the combination of the camera unit 200, which includes the additional function device 250 of the camera, and the inspection signal generator 101 of the third embodiment.

Thus, various modified examples of external environment change are conceivable. A light shutter may be installed in front of the imaging element and opened and closed according to the inspection signal (e.g., liquid crystal type). The aperture (aperture) may be adjusted according to the inspection signal. Alternatively, the focus adjustment mechanism may be adjusted according to the inspection signal. Furthermore, in some embodiments, the sensitivity (ISO sensitivity, etc.) of the CMOS sensor (imaging element) may be adjusted according to the inspection signal. The sensitivity (ISO sensitivity, etc.) of the CMOS sensor may be adjusted on the amplifier side rather than the pixel itself. An intentional reset or power cutoff of the pixel element itself may also be performed.

Here, it is conceivable that the change time required for inspection may be longer than one frame due to the response time limitation of the camera mechanism, but as described in the modified example of the inspection time above, it can be applied as a lower frequency inspection. This disclosure is applicable to one-time inspections of permanent failures or periodic inspections at each meantime between failures. As a one-time inspection, it may be inspected at least once, such as when the car is started.

Referring to FIG. 3, which schematically shows the operation of the second embodiment described above, here, a bit of the inspection signal is applied to each frame, but in this case, frames are inspected with a 50% probability in the long term. This is effectively equivalent to halving the frame rate related to actual operation. For example, if the inspection interval is about once per second, this camera inspection method would result in excessive inspection. Therefore, by applying one bit per second instead of one bit per frame, the frequency of inspection can be optimized.

For example, if the number of frames transmitted per second is 30 (frame rate = 30fps), the 1st to 29th frames are normal image frames, and the 30th frame is the inspection frame, and the ON/OFF information of the inspection signal is applied only to the inspection frame.

Here, which frame per second is used as the inspection frame can be appropriately set according to the notification from the MCU. This idea can be extended to define one inspection frame for a number of frames with a period longer than one second, allowing for lower frequency inspection. Also, the inspection frame may be multiple consecutive frames rather than a single frame, or multiple non-consecutive frames for redundancy.

It is possible to inspect the presence or absence of image sticking in an in-vehicle camera without performing complex calculations, and it can be applied to highly available systems such as autonomous driving systems.

Although the invention made by the present inventor has been specifically described based on the embodiment, the present invention is not limited to the aforementioned embodiment, and it is needless to say that various modifications can be made without departing from the gist thereof.

What is claimed is:

1. A camera inspection system comprising:
an external environment changer that receives an inspection signal and changes the imaging illuminance of a camera fixed to a vehicle, thereby changing the brightness within a frame image captured by the camera;
an average brightness calculator that calculates the average brightness within the image for each frame image captured by the camera over a predetermined period; and
an inspector that compares the inspection signal with the average brightness within the image for each frame image and generates a fault detection signal indicating image sticking when the timing of changes in the inspection signal does not match the timing of changes in the average brightness within the image.

2. The camera inspection system according to claim 1,
wherein the external environment changer includes the camera fixed to the vehicle, an inspection signal generator that generates an inspection signal that periodically switches on and off, and a light that receives the inspection signal and can change the imaging illuminance of at least part of the field of view captured by the camera according to the period of the inspection signal.

3. The camera inspection system according to claim 1,
wherein the external environment changer includes the camera fixed to the vehicle, an inspection signal generator that generates a periodically varying inspection signal, and a camera auxiliary function device that receives the inspection signal and periodically activates the camera's auxiliary functions according to the period of the inspection signal.

4. The camera inspection system according to claim 1 further comprising an image processing device that removes the frame image corresponding to the generated fault detection signal and complements the image based on the frame images before and after the removed frame image.

5. The camera inspection system according to claim 4,
wherein the image processing device performs object recognition based on the complemented image derived from the frame images before and after the removed frame image.

6. The camera inspection system according to claim 1,
wherein the average brightness within the image is the average brightness of all pixels within the image or the local average brightness of predetermined local areas within the image.

7. The camera inspection system according to claim 1,
wherein the inspection signal is a periodically varying signal, and the external environment changer receives the inspection signal and periodically changes the imaging illuminance of the camera fixed to the vehicle, thereby periodically changing the brightness within the frame image captured by the camera, and the inspector compares the inspection signal with the average brightness within the image for each frame image and generates a fault detection signal indicating image sticking when the timing of the period of the inspection signal does not match the timing of the period of changes in the average brightness within the image.

8. The camera inspection system according to claim 1,
wherein the inspection signal is a PRBS (Pseudo Random Binary Sequence) signal.

9. A camera inspection method comprising:
receiving an inspection signal and changing the imaging illuminance of a camera fixed to a vehicle, thereby changing the brightness within a frame image captured by the camera;
calculating the average brightness within the image for each frame image captured by the camera over a predetermined period; and comparing the inspection signal with the average brightness within the image for each frame image and generating a fault detection signal indicating image sticking when the timing of changes in the inspection signal does not match the timing of changes in the average brightness within the image.
